(19) United States
(12) Patent Application Publication
(10) Pub. No.: US 2023/0403701 A1
(43) Pub. Date: Dec. 14, 2023

(54) Methods For Simultaneous PUCCH And PUSCH Transmissions In Intra-Band Carrier Aggregation

(71) Applicant: MediaTek Singapore Pte. Ltd., Singapore (SG)

(72) Inventors: Abdellatif Salah, Cambridge (GB); Mohammed S Aleabe Al-Imari, Cambridge (GB)

(21) Appl. No.: 18/033,288

(22) PCT Filed: Oct. 21, 2021
(86) PCT No.: PCT/CN2021/125160

§ 371 Date: Apr. 21, 2023

Related U.S. Application Data
(60) Provisional application No. 63/104,638, filed on Oct. 23, 2020.

(51) Int. Cl. H04W 72/1268; H04L 5/00

(52) U.S. Cl. CPC H04W 72/1268; H04L 5/0044

(57) ABSTRACT

Various solutions for simultaneous physical uplink control channel (PUCCH) and physical uplink shared channel (PUSCH) transmissions in intra-band carrier aggregation (CA) in mobile communications are described. An apparatus, implementable in a UE, receives a signal from a network. The apparatus then performs simultaneous physical uplink control channel (PUCCH) and physical uplink shared channel (PUSCH) transmissions over different cells of the network responsive to receiving the signal.

### CROSS REFERENCE TO RELATED PATENT APPLICATION

The present disclosure is part of U.S. National Stage filing of International Patent Application No. PCT/CN2021/125160, filed 21 Oct. 2021, which is part of a non-provisional application claiming the priority benefit of U.S. Patent Application No. 63/104,638, filed on 23 Oct. 2020, the content of which being incorporated by reference in its entirety.

### TECHNICAL FIELD

The present disclosure is generally related to mobile communications and, more particularly, to techniques for simultaneous physical uplink control channel (PUCCH) and physical uplink shared channel (PUSCH) transmissions in intra-band carrier aggregation (CA) in mobile communications.

### BACKGROUND

Unless otherwise indicated herein, approaches described in this section are not prior art to the claims listed below and are not admitted as prior art by inclusion in this section.

In wireless communications, such as mobile communications under the 3rd Generation Partnership Project (3GPP) specification(s) for 5th Generation (5G) New Radio (NR), prioritization rules for the overlapping between PUSCH and PUCCH with different priorities remain to be defined. On one hand, enhanced Mobile BroadBand (eMBB) uplink control information (UCI) carried on PUCCH is generally large and sent with a low priority. On the other hand, Ultra-Reliable Low-Latency Communication (URLLC) PUSCH is generally sent with a high priority. Hence, multiplexing the low-priority eMBB PUCCH and the high-priority URLLC PUSCH is not a reasonable approach and there is a high risk for the URLLC PUSCH to miss the reliability and latency requirements. Also, support for simultaneous PUCCH/PUSCH transmissions on different cells for intra-band CA still needs to be defined. Therefore, there is a need for a solution of simultaneous PUCCH and PUSCH transmissions in intra-band CA in mobile communications.

### SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions for simultaneous PUCCH and PUSCH transmissions in intra-band CA in mobile communications.

In one aspect, a method may involve a UE receiving a signal from a network. The method may also involve the UE performing simultaneous PUCCH and PUSCH transmissions over different cells of the network responsive to receiving the signal.

In another aspect, an apparatus may include a transceiver and a processor coupled to the transceiver. The transceiver may be configured to wirelessly communicate with a network. The processor may receive, via the transceiver, a signal from the network. The processor may then perform simultaneous PUCCH and PUSCH transmissions over different cells of the network responsive to receiving the signal.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a block diagram of an example communication apparatus and an example network apparatus in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to simultaneous PUCCH and PUSCH transmissions in intra-band CA in mobile communications. According to the present disclosure, a number of possible solutions may be implemented separately or jointly. That is, although these possible solutions may be described below separately, two or more of these possible solutions may be implemented in one combination or another.

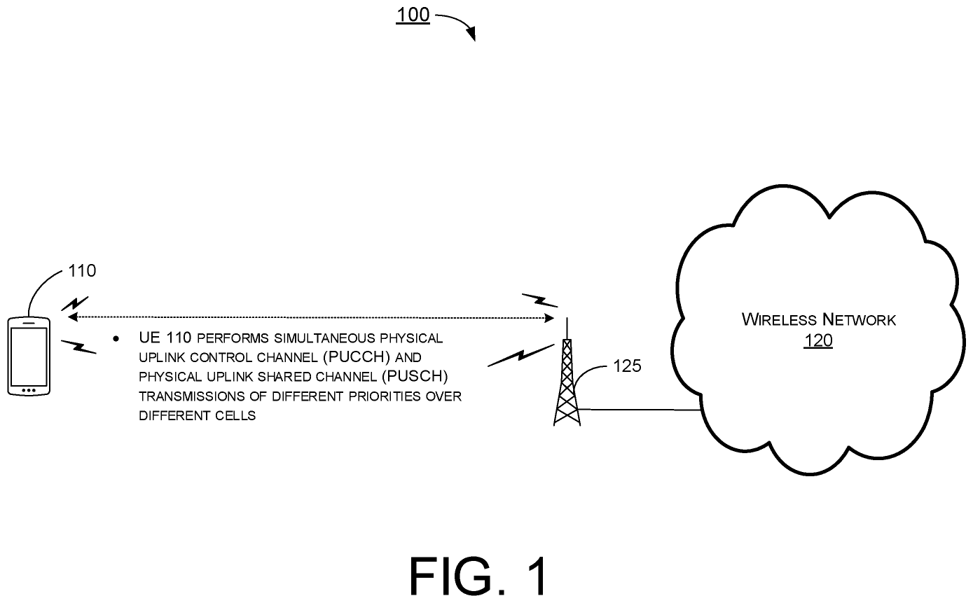

FIG. 1 illustrates an example network environment 100 in which various solutions and schemes in accordance with the present disclosure may be implemented. Referring to FIG. 1, network environment 100 may involve a user equipment (UE) 110 in wireless communication with a wireless network 120 (e.g., a 5G NR mobile network and/or another type of network such as a LTE network, a LTE-Advance network, a NB-IoT network, an IoT network, an IIoT network and/or an NTN). UE 110 may be in wireless communication with wireless network 120 via a base station or network node 125 (e.g., an eNB, gNB or transmit-receive point (TRP)). In network environment 100, UE 110 and wireless network 120 may implement various schemes pertaining to simultaneous PUCCH and PUSCH transmissions in intra-band CA in mobile communications, as described below.

One possible option with respect to the aforementioned issued is to postpone the eMBB PUCCH and give priority to the URLLC PUSCH transmission. This would work without creating any superfluous retransmissions. However, this option would delay the eMBB traffic and also would require some base station scheduling to query the delayed PUCCH.

Another option is to transmit PUCCH and PUSCH simultaneously on different carriers. Simultaneous PUSCH transmissions on different carriers is already supported since Release 15 (Rel-15) of the 3GPP specification. This option would avoid dropping or postponing low-priority transmissions without high cost. Nevertheless, how simultaneous PUCCH/PUSCH transmissions on different cells for intra-band CA is supported needs to be defined.

Under a proposed scheme in accordance with the present disclosure, there may be multiple options regarding the aspect of capability and reporting with respect to simultaneous PUCCH/PUSCH transmissions on different cells for inter-band CA and intra-band CA. A first option may involve defining simultaneous PUCCH/PUSCH transmissions on different cells for inter-band CA as an optional UE capability. A second option may involve configuring simultaneous PUCCH/PUSCH transmissions on different cells for inter-band CA as a feature supported for some inter-band combinations and, thus, this feature or capability may be reported per band combination. A third option may involve defining simultaneous PUCCH/PUSCH transmissions on different cells for intra-band CA as an optional feature and, thus, this feature or capability may be reported per band. A fourth option may involve providing separate UE features since simultaneous PUCCH/PUSCH transmissions require different implementations in inter-band CA and intra-band CA.

Under a proposed scheme in accordance with the present disclosure, there may be multiple options regarding the aspect of support per numerology with respect to simultaneous PUCCH/PUSCH transmissions on different cells for inter-band CA and intra-band CA. A first option may involve supporting simultaneous PUCCH/PUSCH transmissions with the same numerology for intra-band CA. A second option may involve not supporting simultaneous PUCCH/PUSCH transmissions for different numerologies for intra-band CA.

Under a proposed scheme in accordance with the present disclosure, there may be multiple options regarding the aspect of transmission alignment with respect to simultaneous PUCCH/PUSCH transmissions on different cells for inter-band CA and intra-band CA. A first option may involve supporting simultaneous PUCCH/PUSCH transmissions for different numerologies for intra-band CA in an event that the transmissions are aligned on symbol level (e.g., with the symbol of the lowest subcarrier spacing (SCS) as a reference). A second option may involve supporting simultaneous PUCCH/PUSCH transmissions on different cells for intra-band CA under a certain condition. For instance, the condition may involve the start time and the end time of the simultaneous PUCCH/PUSCH transmissions on different cells following the resolution of the carrier with the smallest SCS. A third option may involve requiring the start time and the end time of simultaneous PUCCH/PUSCH uplink (UL) channels to be aligned across component carriers (CCs).

Under a proposed scheme in accordance with the present disclosure, with respect to simultaneous PUCCH/PUSCH transmissions, a UE (e.g., UE 110) may be configured by a higher-layer parameter to enable and disable simultaneous PUCCH/PUSCH transmissions. In a first option, the higher-layer parameter may be configured per cell group or PUCCH group. For instance, the simultaneous PUCCH/PUSCH transmissions may be enabled and disabled per cell group or PUCCH group. In a second option, the higher-layer parameter may be configured separately for inter-band and intra-band simultaneous PUCCH/PUSCH transmissions. For instance, the simultaneous PUCCH/PUSCH transmissions may be enabled and disabled separately for inter-band and intra-band transmissions. In a third option, a radio resource control (RRC) parameter may be utilized to enable simultaneous PUCCH/PUSCH transmissions. For instance, in case the RRC parameter is absent (e.g., not received by UE 110), the simultaneous PUCCH/PUSCH transmissions may be disabled. In a fourth option, the higher-layer parameter may be configured separately for different priorities on transmissions. For instance, the simultaneous PUCCH/PUSCH transmissions may be enabled only for channels with a high physical layer (PHY)-level priority. As another example, for a UE (e.g., UE 110) with the capability of inter-band CA, simultaneous PUCCH/PUSCH transmissions of different PHY-level priorities over different cells may be configured by a network (e.g., network 120 through network node 125) via RRC signaling (e.g., with an RRC parameter) within the same PUCCH group.

Under a proposed scheme in accordance with the present disclosure, simultaneous PUCCH/PUSCH transmissions may be enabled between PUCCH and PUSCH of different priorities. In a first option, in an event that PUSCH and PUCCH have different PHY-level priorities, the simultaneous PUCCH/PUSCH transmissions may be enabled. Otherwise, in an event that the PUCCH and PUSCH have the same PHY-level priority, the PUCCH and PUSCH may be multiplexed. In a second option, a higher-layer parameter may be utilized to enable and disable simultaneous PUCCH/PUSCH transmissions for PUCCH and PUSCH of different priorities. In a third option, a higher-layer parameter may be utilized to enable and disable simultaneous PUCCH/PUSCH transmissions for PUCCH and PUSCH of the same priority.

Under a proposed scheme in accordance with the present disclosure, simultaneous PUCCH/PUSCH transmissions may be enabled between PUCCH and PUSCH of different priorities in an event that the low-priority channel would have been dropped otherwise. For instance, in case the PUSCH and PUCCH have different PHY-level priorities and cannot be multiplexed (e.g., the low-priority channel would have been dropped based on prioritization rules defined in Release 16 (Rel-16) and Release 17 (Rel-17) of the 3GPP specification), the simultaneous PUCCH/PUSCH transmissions may be enabled in this case. Otherwise, in case the PUSCH and PUCCH can be multiplexed (e.g., based on Rel-17 multiplexing rules between channels of different PHY-level priorities), then the PUSCH and PUCCH may be multiplexed. Under the proposed scheme, for PUCCH and PUSCH of different priorities, UE 110 may be configured to perform either simultaneous PUCCH/PUSCH transmissions or multiplexing the PUCCH and PUSCH of different priorities.

Under a proposed scheme in accordance with the present disclosure, simultaneous PUCCH/PUSCH transmissions may be enabled based on specific conditions. In a first option, the conditions may be enabled or disabled using higher-layer parameter(s). In a second option, the conditions may be specified and enabled/disabled using higher-layer parameter(s). In a third option, simultaneous PUCCH/PUSCH transmissions may be enabled in case the low-priority PUCCH (LP-PUCCH) carries hybrid automatic repeat request (HARQ) feedback. For instance, in case the LP-PUCCH does not carry HARQ feedback, simultaneous PUCCH/PUSCH transmissions may be disabled and the prioritization rules of Rel-16/Rel-17 may be performed (e.g., dropping the LP-PUCCH). In a fourth option, simultaneous PUCCH/PUSCH transmissions may be enabled in case the LP-PUCCH carries data (e.g., an uplink shared channel (UL-SCH) being transmitted on the low-priority PUSCH (LP-PUSCH)). For instance, in case the LP-PUSCH carries only channel state information (CSI) and no data, simultaneous PUCCH/PUSCH transmissions may be disabled and the prioritization rules of Rel-16/Rel-17 may be performed (e.g., dropping the LP-PUSCH). In a fifth option, simultaneous PUCCH/PUSCH transmissions may be enabled in case a high-priority PUCCH (HP-PUCCH) is of a specific PUCCH format. For instance, in case the HP-PUCCH is of PUCCH format-0, simultaneous PUCCH/PUSCH transmissions may be enabled. Otherwise, the prioritization rules of Rel-16/Rel-17 may be performed (e.g., dropping the LP-PUSCH).

### Illustrative Implementations

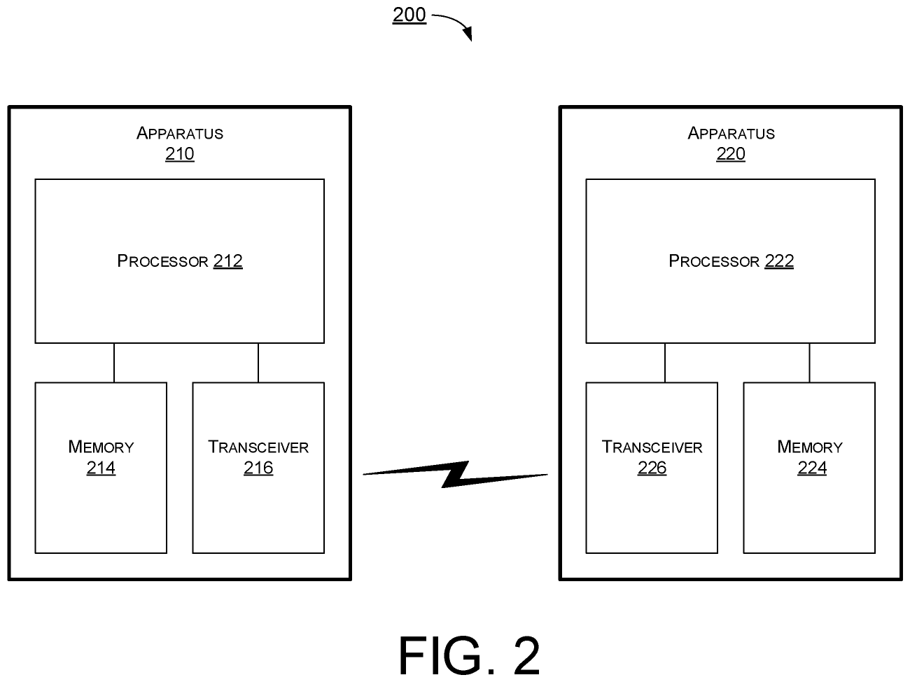

FIG. 2 illustrates an example communication apparatus 210 and an example network apparatus 220 in accordance with an implementation of the present disclosure. Each of communication apparatus 210 and network apparatus 220 may perform various functions to implement schemes, techniques, processes and methods described herein pertaining to simultaneous PUCCH and PUSCH transmissions in intra-band CA in mobile communications, including scenarios/schemes described above as well as processes described below.

Communication apparatus 210 may be a part of an electronic apparatus, which may be a UE such as a portable or mobile apparatus, a wearable apparatus, a wireless communication apparatus or a computing apparatus. For instance, communication apparatus 210 may be implemented in a smartphone, a smartwatch, a personal digital assistant, a digital camera, or a computing equipment such as a tablet computer, a laptop computer or a notebook computer. Communication apparatus 210 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 210 may be implemented in a smart thermostat, a smart fridge, a smart door lock, a wireless speaker or a home control center. Alternatively, communication apparatus 210 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 210 may include at least some of those components shown in FIG. 2 such as a processor 212, for example. Communication apparatus 210 may further include one or more other components not pertinent to the proposed scheme of the present disclosure (e.g., internal power supply, display device and/or user interface device), and, thus, such component(s) of communication apparatus 210 are neither shown in FIG. 2 nor described below in the interest of simplicity and brevity.

Network apparatus 220 may be a part of an electronic apparatus/station, which may be a network node such as a base station, a small cell, a router, a gateway or a satellite. For instance, network apparatus 220 may be implemented in an eNodeB in an LTE, in a gNB in a 5G, NR, IoT, NB-IoT, IIoT, or in a satellite in an NTN network. Alternatively, network apparatus 220 may be implemented in the form of one or more IC chips such as, for example and without limitation, one or more single-core processors, one or more multi-core processors, or one or more RISC or CISC processors. Network apparatus 220 may include at least some of those components shown in FIG. 2 such as a processor 222, for example. Network apparatus 220 may further include one or more other components not pertinent to the proposed scheme of the present disclosure (e.g., internal power supply, display device and/or user interface device), and, thus, such component(s) of network apparatus 220 are neither shown in FIG. 2 nor described below in the interest of simplicity and brevity.

In one aspect, each of processor 212 and processor 222 may be implemented in the form of one or more single-core processors, one or more multi-core processors, one or more RISC processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks including simultaneous PUCCH and PUSCH transmissions in intra-band CA in mobile communications in accordance with various implementations of the present disclosure.

In some implementations, communication apparatus 210 may also include a transceiver 216 coupled to processor 212 and capable of wirelessly transmitting and receiving data. In some implementations, communication apparatus 210 may further include a memory 214 coupled to processor 212 and capable of being accessed by processor 212 and storing data therein. In some implementations, network apparatus 220 may also include a transceiver 226 coupled to processor 222 and capable of wirelessly transmitting and receiving data. In some implementations, network apparatus 220 may further include a memory 224 coupled to processor 222 and capable of being accessed by processor 222 and storing data therein. Accordingly, communication apparatus 210 and network apparatus 220 may wirelessly communicate with each other via transceiver 216 and transceiver 226, respectively.

Each of communication apparatus 210 and network apparatus 220 may be a communication entity capable of communicating with each other using various proposed schemes in accordance with the present disclosure. To aid better understanding, the following description of the operations, functionalities and capabilities of each of communication apparatus 210 and network apparatus 220 is provided in the context of a mobile communication environment in which communication apparatus 210 is implemented in or as a communication apparatus or a UE (e.g., UE 110) and network apparatus 220 is implemented in or as a network node or base station (e.g., network node 125) of a communication network (e.g., wireless network 120). It is also noteworthy that, although the example implementations described below are provided in the context of mobile communications, the same may be implemented in other types of networks.

Under various proposed schemes pertaining to simultaneous PUCCH and PUSCH transmissions in intra-band CA in mobile communications in accordance with the present disclosure, with communication apparatus 210 implemented in or as UE 110 and network apparatus 220 implemented in or as network node 125 in network environment 100, processor 212 of communication apparatus 210 may receive, via transceiver 216, a signal from a network (e.g., network 120 via apparatus 220 as network node 125). Additionally, processor 212 may perform, via transceiver 216, simultaneous PUCCH and PUSCH transmissions over different cells of the network responsive to receiving the signal.

In some implementations, the signal may include a higher-layer parameter configured per PUCCH group. Alternatively, the signal may include a higher-layer parameter configured per cell group.

In some implementations, the signal may include a higher-layer parameter used to enable and disable the simultaneous PUCCH and PUSCH transmissions of different priorities.

In some implementations, in receiving the signal, processor 212 may receive an RRC signal containing an RRC parameter. In such cases, the performing of the simultaneous PUCCH and PUSCH transmissions with different or same priorities may be disabled or enabled responsive to an absence or a presence of the RRC parameter. In some implementations, the RRC parameter may be configured separately by the network (e.g., via apparatus 220 as network node 125) for inter-band and intra-band simultaneous PUCCH and PUSCH transmissions.

In some implementations, in performing the simultaneous PUCCH and PUSCH transmissions, processor 212 may perform the simultaneous PUCCH and PUSCH transmissions between a PUCCH and a PUSCH of different priorities. In such cases, the signal may enable the simultaneous PUCCH and PUSCH transmissions responsive to the PUCCH and the PUSCH having different PHY-level priorities. Moreover, in performing the simultaneous PUCCH and PUSCH transmissions, processor 212 may perform simultaneous transmissions of: (a) a HP-PUCCH and a LP-PUSCH, or (b) a LP-PUCCH and a HP-PUSCH. Furthermore, in performing the simultaneous PUCCH and PUSCH transmissions, processor 212 may perform simultaneous transmissions of URLLC and eMBB over different cells.

### Illustrative Processes

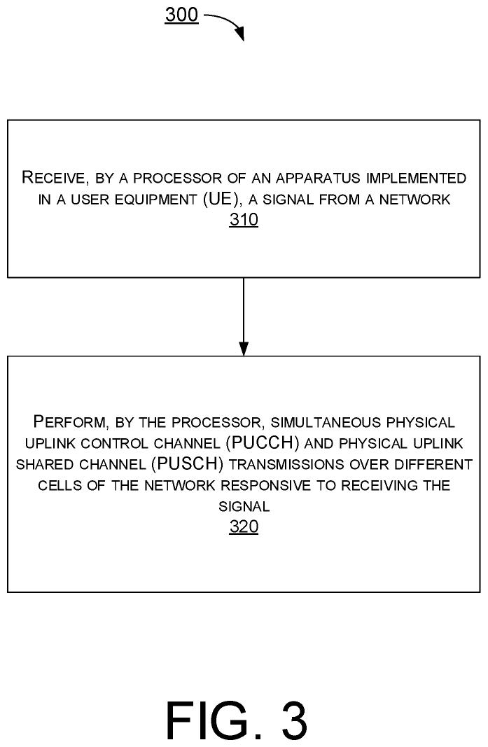

FIG. 3 illustrates an example process 300 in accordance with an implementation of the present disclosure. Process 300 may be an example implementation of schemes described above whether partially or completely, with respect to simultaneous PUCCH and PUSCH transmissions in intra-band CA in mobile communications in accordance with the present disclosure. Process 300 may represent an aspect of implementation of features of communication apparatus 210 and network apparatus 220. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Process 300 may be implemented by communication apparatus 210 or any suitable UE or machine type devices as well as by and network apparatus 220 or any suitable network node or base station. Solely for illustrative purposes and without limitation, process 300 is described below in the context of communication apparatus 210 implemented in or as UE 110 and network apparatus 220 implemented in or as network node 125. Process 300 may begin at block 310.

At 310, process 300 may involve processor 212 of communication apparatus 210, implemented in or as UE 110, receiving, via transceiver 216, a signal from a network (e.g., network 120 via apparatus 220 as network node 125). Process 300 may proceed from 310 to 320.

At 320, process 300 may involve processor 212 performing, via transceiver 216, simultaneous PUCCH and PUSCH transmissions over different cells of the network responsive to receiving the signal.

In some implementations, the signal may include a higher-layer parameter configured per PUCCH group. Alternatively, the signal may include a higher-layer parameter configured per cell group.

In some implementations, the signal may include a higher-layer parameter used to enable and disable the simultaneous PUCCH and PUSCH transmissions of different priorities.

In some implementations, in receiving the signal, process 300 may involve processor 212 receiving an RRC signal containing an RRC parameter. In such cases, the performing of the simultaneous PUCCH and PUSCH transmissions with different or same priorities may be disabled or enabled responsive to an absence or a presence of the RRC parameter. In some implementations, the RRC parameter may be configured separately by the network (e.g., via apparatus 220 as network node 125) for inter-band and intra-band simultaneous PUCCH and PUSCH transmissions.

In some implementations, in performing the simultaneous PUCCH and PUSCH transmissions, process 300 may involve processor 212 performing the simultaneous PUCCH and PUSCH transmissions between a PUCCH and a PUSCH of different priorities. In such cases, the signal may enable the simultaneous PUCCH and PUSCH transmissions responsive to the PUCCH and the PUSCH having different PHY-level priorities. Moreover, in performing the simultaneous PUCCH and PUSCH transmissions, process 300 may involve processor 212 performing simultaneous transmissions of: (a) a HP-PUCCH and a LP-PUSCH, or (b) a LP-PUCCH and a HP-PUSCH. Furthermore, in performing the simultaneous PUCCH and PUSCH transmissions, process 300 may involve processor 212 performing simultaneous transmissions of URLLC and eMBB over different cells.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
receiving, by a processor of an apparatus implemented in a user equipment (UE), a signal from a network; and
performing, by the processor, simultaneous physical uplink control channel (PUCCH) and physical uplink shared channel (PUSCH) transmissions over different cells of the network responsive to receiving the signal.

2. The method of claim 1, wherein the signal comprises a higher-layer parameter configured per PUCCH group.

3. The method of claim 1, wherein the signal comprises a higher-layer parameter configured per cell group.

4. The method of claim 1, wherein the signal comprises a higher-layer parameter used to enable and disable the simultaneous PUCCH and PUSCH transmissions of different priorities.

5. The method of claim 1, wherein the receiving of the signal comprises receiving a radio resource control (RRC) signal containing an RRC parameter.

6. The method of claim 5, wherein the performing of the simultaneous PUCCH and PUSCH transmissions with different or same priorities is disabled or enabled responsive to an absence or a presence of the RRC parameter.

7. The method of claim 6, wherein the RRC parameter is configured separately for inter-band and intra-band simultaneous PUCCH and PUSCH transmissions.

8. The method of claim 1, wherein the performing of the simultaneous PUCCH and PUSCH transmissions comprises performing the simultaneous PUCCH and PUSCH transmissions between a PUCCH and a PUSCH of different priorities.

9. The method of claim 8, wherein the signal enables the simultaneous PUCCH and PUSCH transmissions responsive to the PUCCH and the PUSCH having different physical layer (PHY)-level priorities.

10. The method of claim 8, wherein the performing of the simultaneous PUCCH and PUSCH transmissions comprise performing simultaneous transmissions of:
a high-priority PUCCH (HP-PUCCH) and a low-priority PUSCH (LP-PUSCH), or
a low-priority PUCCH (LP-PUCCH) and a high-priority PUSCH (HP-PUSCH).

11. The method of claim 8, wherein the performing of the simultaneous PUCCH and PUSCH transmissions comprise performing simultaneous transmissions of Ultra-Reliable Low-Latency Communication (URLLC) and enhanced Mobile BroadBand (eMBB) over different cells.

12. An apparatus implementable in a user equipment (UE), comprising:
a transceiver configured to wirelessly communicate with a network; and
a processor coupled to the transceiver and configured to perform operations comprising:
receiving, via the transceiver, a signal from the network; and
performing, via the transceiver, simultaneous physical uplink control channel (PUCCH) and physical uplink shared channel (PUSCH) transmissions over different cells of the network responsive to receiving the signal.

13. The apparatus of claim 12, wherein the signal comprises a higher-layer parameter configured per PUCCH group.

14. The apparatus of claim 12, wherein the signal comprises a higher-layer parameter configured per cell group.

15. The apparatus of claim 12, wherein the signal comprises a higher-layer parameter used to enable and disable the simultaneous PUCCH and PUSCH transmissions of different priorities.

16. The apparatus of claim 12, wherein, in receiving the signal, the processor is configured to receive a radio resource control (RRC) signal containing an RRC parameter, and wherein the performing of the simultaneous PUCCH and PUSCH transmissions with different or same priorities is disabled or enabled responsive to an absence or a presence of the RRC parameter.

17. The apparatus of claim 12, wherein, in performing the simultaneous PUCCH and PUSCH transmissions, the processor is configured to perform the simultaneous PUCCH and PUSCH transmissions between a PUCCH and a PUSCH of different priorities.

18. The apparatus of claim 17, wherein the signal enables the simultaneous PUCCH and PUSCH transmissions responsive to the PUCCH and the PUSCH having different physical layer (PHY)-level priorities.

19. The apparatus of claim 17, wherein, in performing the simultaneous PUCCH and PUSCH transmissions, the processor is configured to perform simultaneous transmissions of:
a high-priority PUCCH (HP-PUCCH) and a low-priority PUSCH (LP-PUSCH), or
a low-priority PUCCH (LP-PUCCH) and a high-priority PUSCH (HP-PUSCH).

20. The apparatus of claim 17, wherein, in performing the simultaneous PUCCH and PUSCH transmissions, the processor is configured to perform simultaneous transmissions of Ultra-Reliable Low-Latency Communication (URLLC) and enhanced Mobile BroadBand (eMBB) over different cells.
